(19) United States
(12) Patent Application Publication
(10) Pub. No.: US 2017/0191719 A1
(43) Pub. Date: Jul. 6, 2017

(54) REFRIGERANT MANAGEMENT SYSTEM WITH OPERATIONAL EFFICIENCY IMPROVEMENT DEVICES

(71) Applicant: Ritchie Engineering Company, Inc., Bloomington, MN (US)

(72) Inventors: RONALD A. PLASEK, Lakeville, MN (US); KARL JOHNSON, St. Michael, MN (US); PETER TRUITT, St. Paul, MN (US)

(21) Appl. No.: 14/989,403

(22) Filed: Jan. 6, 2016

(51) Int. Cl. F25B 45/00; F25B 49/02; B60H 1/00

(52) U.S. Cl. CPC F25B 45/00; B60H 1/00585; F25B 49/02; F25B 2345/0052; F25B 2345/001; F25B 2345/002; F25B 2345/003; F25B 2345/004

(57) ABSTRACT

A refrigerant management system is interchangeably connectable to a plurality of refrigeration systems and can manage one or more connected refrigeration systems. The refrigerant management system includes a portable system housing for securing various components in a self-contained unit. The refrigerant management system includes a work panel that can be arranged on the top of the system housing. The work panel includes various operational efficiency improvement devices that allow a user to use, store and organize various movable items that would otherwise be carried separately from the refrigerant management system.

### BACKGROUND

Refrigerant management systems are available to assist a user or mechanic in servicing various air conditioning systems. Some examples of refrigerant management systems are adapted to be connected to the high and low pressure sides of an air-conditioning system and includes a device for measuring the high and low side pressures of the system, for draining and evacuating the system, for charging the system with refrigerant and lubricating oil, and for monitoring system performance.

Some refrigerant management systems include a cabinet that supports components of the system. Such a self-contained unit can improve efficiency in operating the system. For example, a user can perform multiple operations through a display screen, a plurality of switches, and a plurality of lights, which are provided on the cabinet of the refrigerant management system. During the operations, the user typically needs other items, such as papers, manuals, instruction sheets, specifications, files, tools, and instruments, which are not stored or contained in the refrigerant management system. Such items can hinder efficient operation of the refrigerant management system.

### SUMMARY

In general terms, this disclosure is directed to a refrigerant management system. In one possible configuration and by non-limiting example, the refrigerant management system includes a work panel with various operational efficiency improvement devices. Various aspects are described in this disclosure, which include, but are not limited to, the following aspects.

One aspect is a refrigerant management system including a housing and a work panel. The housing is configured to secure at least one of an oil extraction reservoir, a storage tank, and a vacuum pump. The work panel is secured to the housing and includes a top portion and a side portion, the work panel including a work surface defined on the top portion. The work surface includes a stand extending from the top portion of the work panel. The stand can have a support surface configured to detachably support a portable control device thereon. The work panel can be arranged at a height that enables a user to access the work surface while standing.

Another aspect is an automotive refrigerant management system including an oil extraction reservoir, a storage tank, a vacuum pump, a portable control interface device, a control device, and a movable system housing, and a work panel. The control interface operates to receive a user input. The control device receives data from the portable control interface device and performs at least one of recovery operation, vacuum operation, charge operation, full cycle operation, and oil injection operation. The movable system housing is configured to secure the oil extraction reservoir, the storage tank, the vacuum pump, and the control device. The work panel is secured to the system housing and includes a stand and a countertop surface. The stand extends from a top portion of the work panel and has a support surface configured to detachably support the portable control interface device. The countertop surface is arranged on the top portion of the work panel.

In certain examples, the system further includes a portable control device. The portable control device provides a user interface for managing a refrigeration system using at least one of the oil extraction reservoir, the storage tank, and the vacuum pump.

In certain examples, the work surface of the work panel includes a countertop surface defined on the top portion of the work panel.

In certain examples, the work panel includes a hose storage device configured to store hoses extending from the refrigerant management system. The hose storage device can include a hose rack extending from the side portion of the work panel. The hose rack provides a wrap surface around which the hoses are at least partially wound.

In certain examples, the work panel includes one or more magnetically attractive portions configured to hold one or more items having a portion made of one or more magnetic or ferromagnetic materials. The work panel further includes one or more magnets attracted to the magnetically attractive portions and configured to hold the one or more items between the magnets and the magnetically attractive portions. The work panel can further include a magnetic hook magnetically attached to the magnetically attractive portions and configured to hold one or more job jackets or other items.

In certain examples, the work panel includes a hanging hook for hanging one or more items, the hook arranged on the side portion of the work panel.

In certain examples, the work panel includes one or more trays defined on the top portion of the work panel.

In certain examples, the work panel includes an interface through which a refrigerant identifying device is connected.

### BRIEF DESCRIPTION OF THE DRAWINGS

FIG. 1 schematically illustrates an system for managing one or more refrigeration systems, according to an example embodiment of the present disclosure

FIG. 2 schematically illustrates an example of a refrigerant management system of FIG. 1.

FIG. 3 illustrates a control device useable in the refrigerant management system of FIGS. 1-2.

FIG. 4 is a front perspective view of a refrigerant management system, according to an example embodiment of the present disclosure.

FIG. 5 is a rear perspective view of the refrigerant management system of FIG. 4.

FIG. 6 illustrates the refrigerant management system with a control interface device and a portable storage removed from a work panel.

FIG. 7 is a top view of the work panel.

FIG. 8 is a front view of the work panel.

FIG. 9 is a rear view of the work panel.

FIG. 10 is a right side view of the work panel.

FIG. 11 is a left side view of the work panel.

FIG. 12 is a bottom side view of the work panel.

FIG. 13 is a cross sectional view of the work panel, taken along line A-A shown in FIG. 13.

FIG. 14 is a schematic perspective view of a hanging hook of the work panel.

FIG. 15 is a schematic perspective view of a magnetic hook of the work panel.

FIG. 16 schematically illustrates an example window of a user interface provided by the control interface device.

FIG. 17 schematically illustrates another example window of the user interface of FIG. 16.

FIG. 18 schematically illustrates yet another example window of the user interface of FIG. 16.

FIG. 19 schematically illustrates yet another example window of the user interface of FIG. 16.

FIG. 20 schematically illustrates yet another example window of the user interface of FIG. 16.

FIG. 21 schematically illustrates yet another example window of the user interface of FIG. 16.

FIG. 22 schematically illustrates an example notification window displayed on the user interface of FIG. 16.

### DETAILED DESCRIPTION

Various embodiments will be described in detail with reference to the drawings, wherein like reference numerals represent like parts and assemblies throughout the several views.

In general, the present disclosure relates to a refrigerant management system. In some embodiments, the refrigerant management system is interchangeably connectable to a plurality of refrigeration systems and can manage one or more connected refrigeration systems. For example, the refrigerant management system can be used at auto repair shops to recover, recycle, and/or recharge a refrigerant of vehicle air conditioners. The refrigerant management system includes a portable system housing for securing various components in a self-contained unit, such as a vacuum pump, a storage tank, an oil extraction reservoir, and other components that are needed to operate the refrigerant management system. In some examples, the system housing includes a transporting device (e.g., wheels) that help move the system housing. When the refrigerant management system is configured to be used to service a vehicle air conditioner, a user or mechanic can move the refrigerant management system to a location close to a vehicle that includes an air conditioning system to be managed, and connect the refrigerant management system to the air conditioning system of the vehicle via hoses. The user or mechanic can then perform a job including one or more maintenance tasks, such as assessing operation of the air conditioning system, flushing the system refrigerant, adding system refrigerant, pressurizing or depressurizing a refrigerant system, or troubleshooting errors in operation of the air conditioning system. Once the job has been done, the refrigerant management system can be moved to a different location to manage an air conditioning system of a different vehicle.

The refrigerant management system of the present disclosure includes a work panel that can be arranged on the top of the system housing. The work panel includes various operational efficiency improvement devices. The operational efficiency improvement devices allow a user to use, store and organize various movable items (e.g., papers, files, instruments, and tools) that would otherwise be carried separately from the refrigerant management system. The devices allow such movable items to be easily accessible within the refrigerant management system, thereby enhancing efficiency in operating the refrigerant management system. For example, although the work panel may in some embodiments be made from a plastic or other non-magnetic material, the work panel includes one or more integrated magnetically attractive portions to which one or more magnets can be attached. The magnets are attached to the magnetically attractive portions to hold one or more items, such as papers, between the magnets and the magnetically attractive portions. The work panel includes one or more magnetic hooks magnetically attachable to the magnetically attractive portions to hang one or more items therefrom. The work panel can further include one or more hanging hook for hanging one or more items. In certain examples, the work panel includes one or more trays defined on the work panel and configured to receive portable items.

The refrigerant management system of the present disclosure can further include a control device detachably supported by the work panel. In certain examples, the control device is configured as a mobile computing device, such as tablet or smartphone, running an application that provides a user interface for controlling the components contained in the refrigerant management system. A user can use the portable control device to enter input for controlling the refrigerant management system and monitor the operational status of the system. While the refrigerant management system is in operation with respect to a connected refrigeration system, a user can remove the portable control device from the work panel and walk away from the refrigerant management system, carrying the portable control device to perform different tasks or to move to different locations. The user need not stay with the refrigerant management system while it operates, thereby improving overall work efficiency.

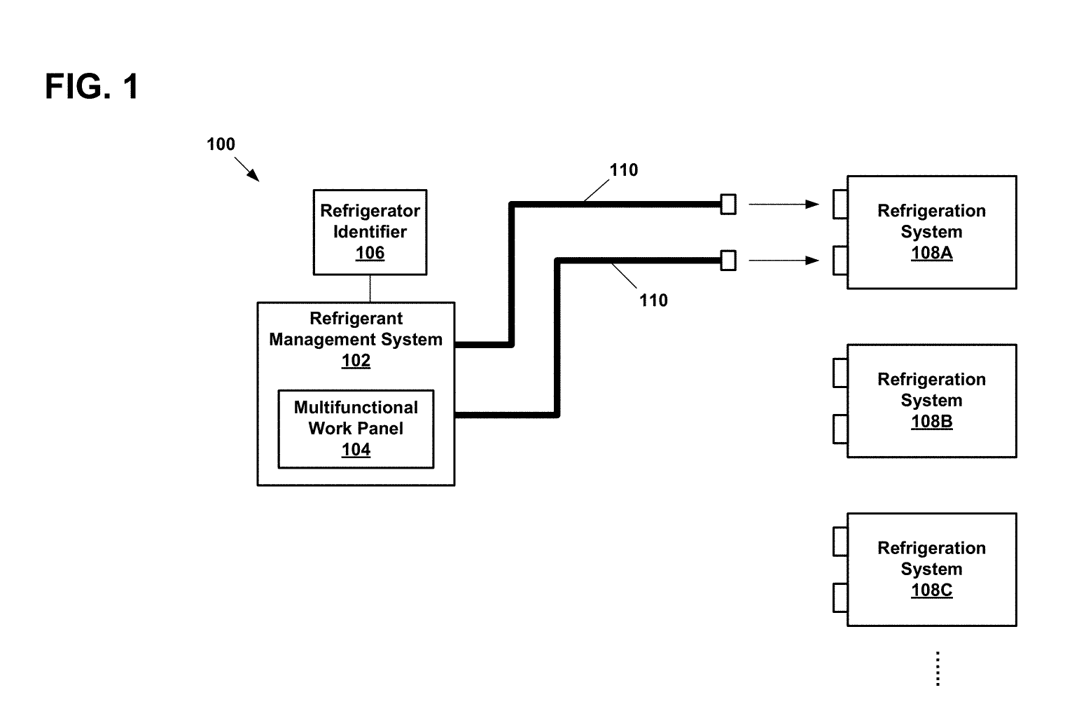

FIG. 1 schematically illustrates an example system 100 for managing one or more refrigeration systems. In this example, the system 100 includes a refrigerant management system 102, which includes a multifunctional work panel 104, a refrigerant identifier 106, and one or more refrigeration systems 108.

The refrigerant management system 102 is connected to at least one of the refrigeration systems 108 and performs various operations for managing the associated refrigeration system 108. The refrigerant management system 102 can be hydraulically/pneumatically connected to a refrigeration system via one or more hoses 110. In some embodiments, the refrigerant management system 102 operates to recover, recycle, and/or recharge a refrigerant of the refrigeration system 108.

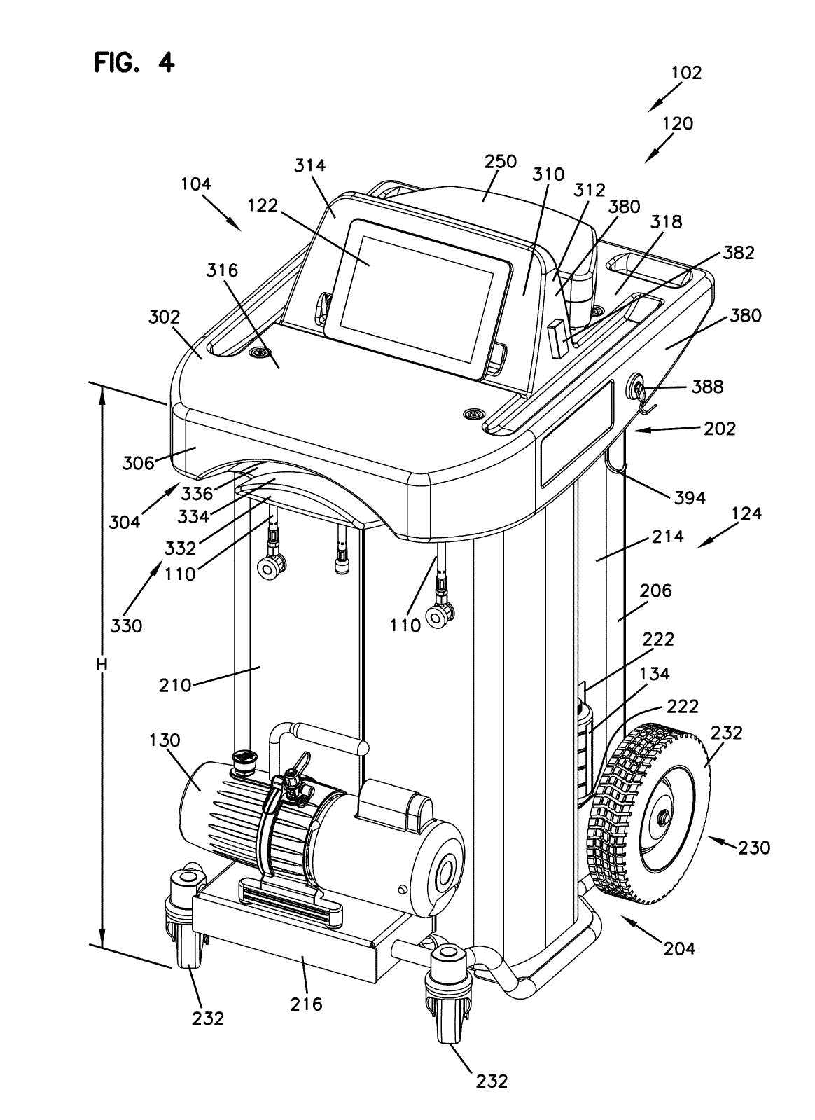

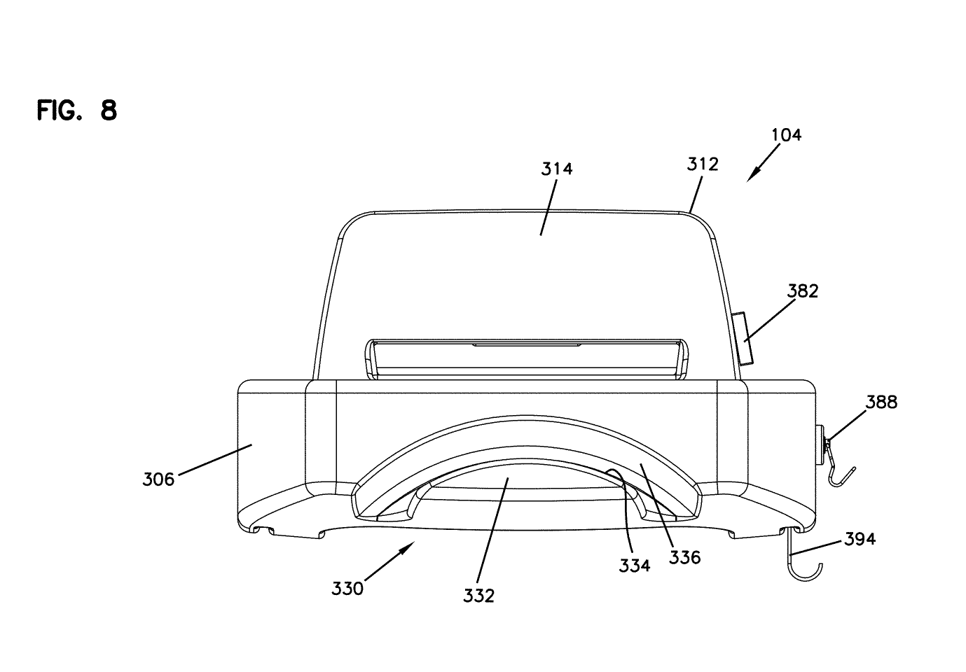

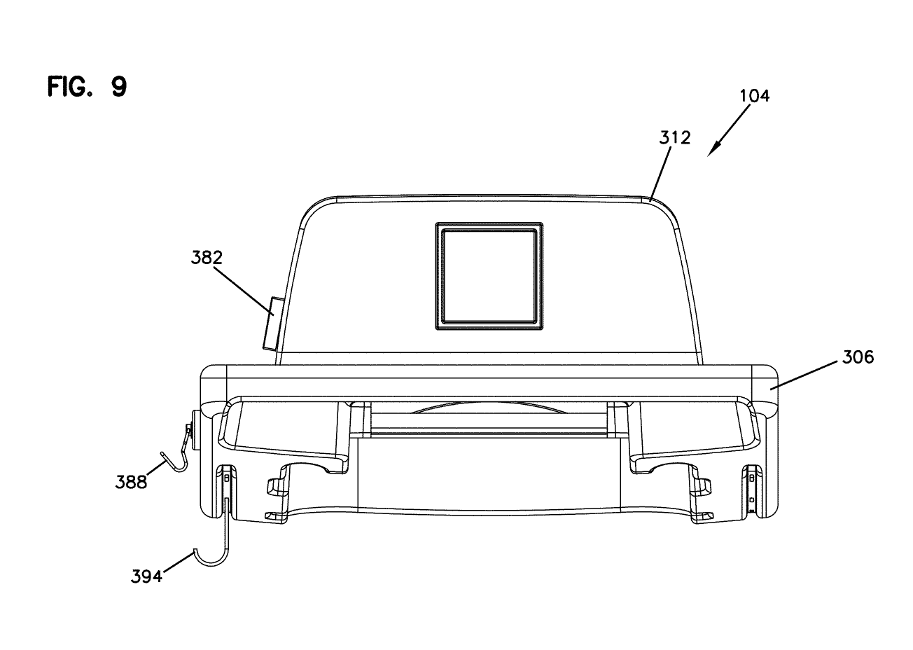

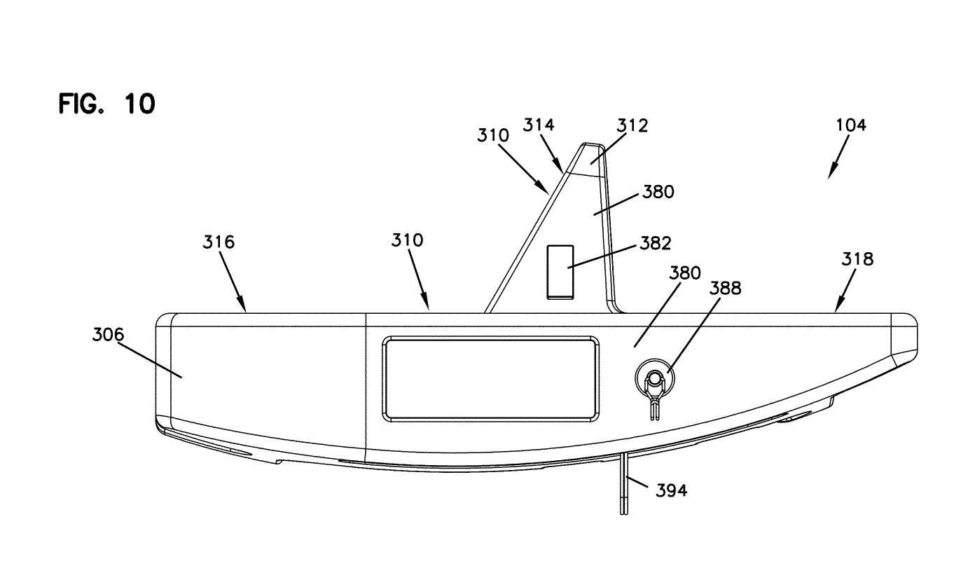

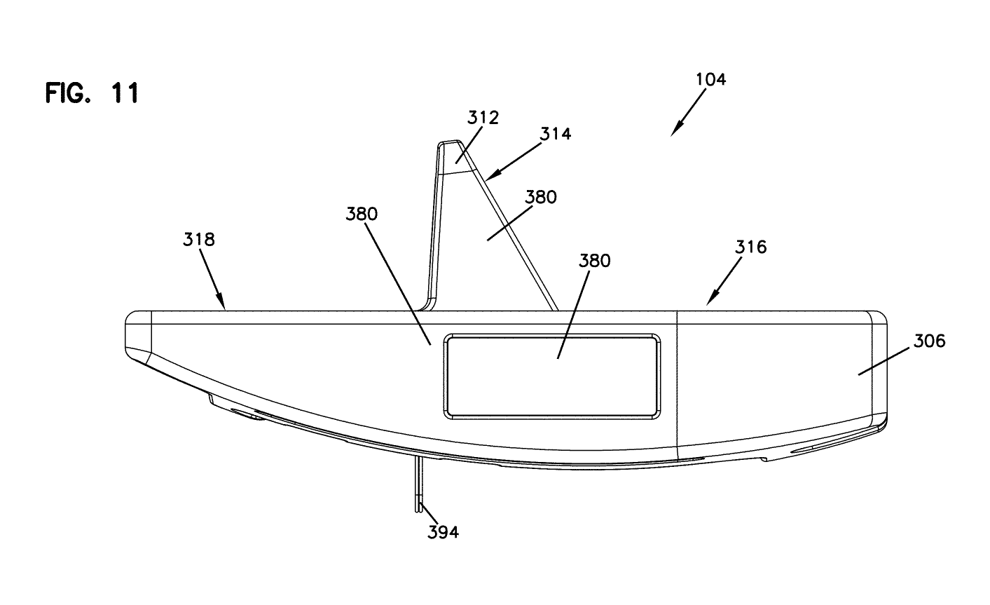

The multifunctional work panel 104 is part of the refrigerant management system 102 and provides one or more devices for improving efficiency in operating the refrigerant management system 102. In some embodiments, the operational efficiency improvement devices provided to the work panel 104 include a work surface with which a user can perform various tasks in operating the refrigerant management system 102. An example of the multifunctional work panel 104 is described with reference to FIGS. 4-13.

The refrigerant identifier 106 operates to identify a refrigerant used in a refrigeration system 108, thereby avoiding a situation in which different refrigerants may be intermixed in a single refrigeration system (leading to malfunction of the refrigeration system and/or in violation of industry regulations). In some embodiments, the refrigerant identifier 106 is connected, either wirelessly or wired, to the refrigerant management system 102 and performs a process for identifying the refrigerant of the refrigeration system 108 connected to the refrigerant management system 102. The work panel 104 can include an interface (e.g., port and/or connector) through which the refrigerant identifier 106 is connected. As described herein, the refrigerant management system 102 is configured to be compatible with various refrigerant identifiers 106 so that different refrigerant identifiers 106 are interchangeably used with the refrigerant management system 102. In other embodiments, the refrigerant identifier 106 is connected directly with one or more refrigeration system 108 (e.g., via hydraulic hoses) and operated without using the refrigerant management system 102.

The refrigeration systems 108 (including 108A-108C) are configured to perform a heat transfer process, moving heat from one location to another in controlled conditions. The refrigeration systems 108 use refrigerants, which are used in a compressor, such as a compression and refrigeration cycle. Some refrigerants are known to cause various environment issues, such as global warming and ozone depletion. Due to such concerns, it is typically prohibited to release refrigerants into the atmosphere. When refrigerants are removed from a refrigeration system 108, the refrigerants can be required to be recycled to clean out any contaminants and return them to a usable condition. The refrigeration systems 108 include air conditioning (A/C) systems (e.g., vehicle air conditioners, household air conditioners, and building air conditioners), household refrigerators, industrial freezers, and other systems using a refrigerant.

In this document, the refrigerant management system 102 is primarily illustrated to manage a refrigeration system 108 that includes a vehicle air conditioning system. In automotive applications such refrigerants can include R134a, which has generally known environmental concerns, as well as HFO-1234yf, which is a less environmentally problematic replacement for R134a. However, the refrigerant management system 102 can also be configured and used for other types of refrigeration systems 108. In such other types of refrigeration systems, other refrigerants may be used.

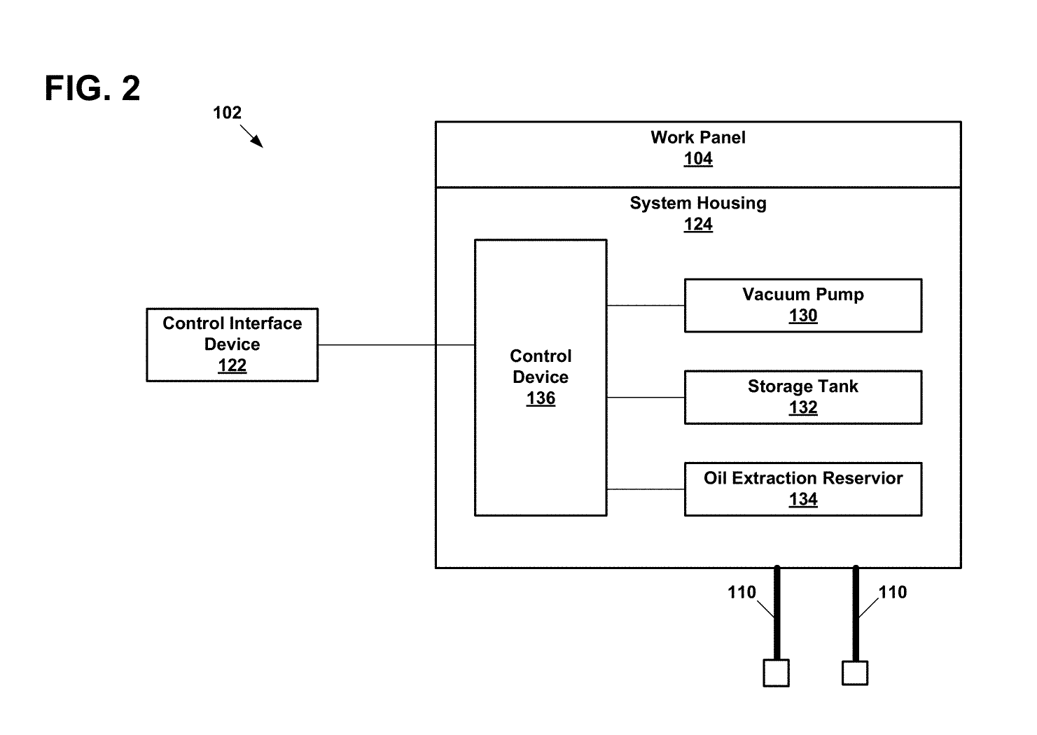

FIG. 2 schematically illustrates an example of the refrigerant management system 102. In some embodiments, the refrigerant management system 102 includes a management unit 120 and a control interface device 122.

The management unit 120 is configured to house various components of the refrigerant management system 102. In some embodiments, the management unit 120 includes a system housing 124 and the work panel 104.

The system housing 124 is configured to secure one or more components of the refrigerant management system 102 so that such components are contained in a single unit. The housing 124 allows a user to conveniently manage and control multiple components of the refrigerant management system 102 in a single location. As discussed herein, the housing 124 can be configured to be portable so that a user can move the housing 124 to different locations as appropriate for operating the refrigerant management system 102 with respect to an associated refrigeration system 108. An example of the housing 124 is illustrated and described in more detail with reference to FIGS. 4-6.

In some embodiments, the components of the refrigerant management system 102 include a vacuum pump 130, a storage tank 132, an oil extraction reservoir 134, and a control device 136. As such, the system housing 124 is configured to secure the storage tank 132, the oil extraction reservoir 134, and other components of the refrigerant management system 102, such as a master manifold and a solenoid. Additional details of such a refrigerant management system 102 are provided in various SAE International standards, which establish equipment performance requirements for recovery, recycling, and recharging for air-conditioning systems. Examples of such standards include SAE J2788 standard, SAE J2843 standard, and SAE 3030 standard, the disclosure of which are hereby incorporated by reference in their entireties.

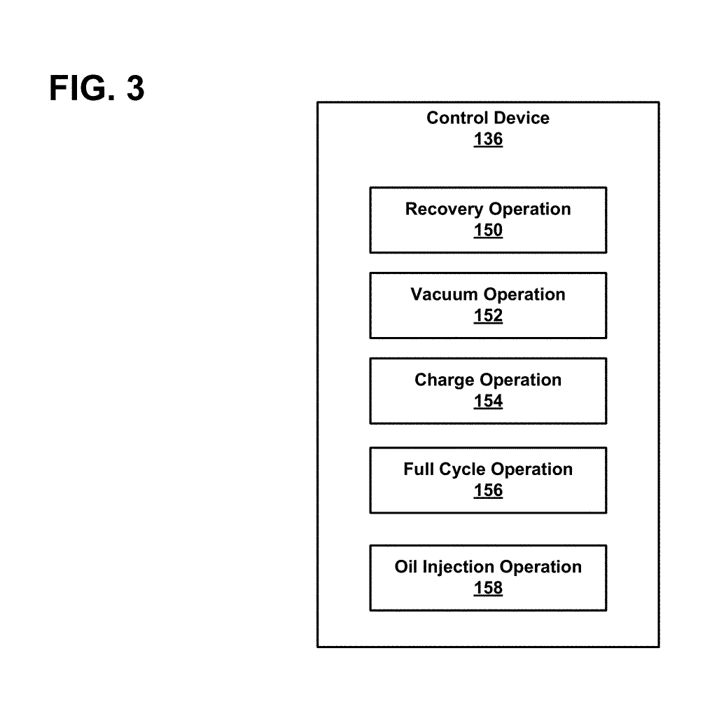

The control device 136 is configured to control the vacuum pump 130, the storage tank 132, the oil extraction reservoir 134, and other components of the refrigerant management system 102. In some embodiments, the control device 136 is configured to selectively control the vacuum pump 130, the storage tank 132, the oil extraction reservoir 134, and other components of the refrigerant management system 102 in various manners depending on different operation modes, as described in FIG. 3.

In some embodiments, the control device 136 operates to receive data from the control interface device 122 and control the components of the refrigerant management system 102 based on the data. The data from the control interface device 122 can include information that can be used to control one or more components of the refrigerant management system 102. As described below, such control information is inputted or selected by a user through the control interface device 122.

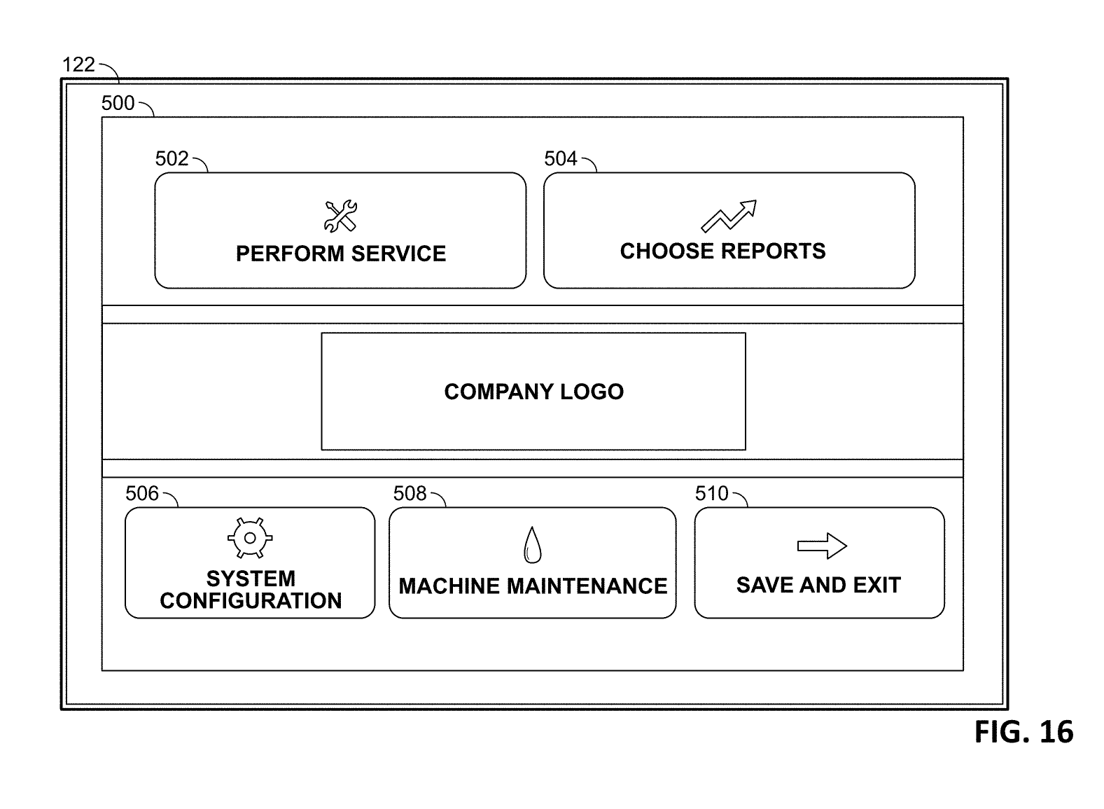

With continued reference to FIG. 2, the control interface device 122 provides an interface through which a user interacts with the control device 136. A user can use the control interface device 122 to enter input for controlling the refrigerant management system 102 and monitor the operational status of the system 102. Example interfaces of the control interface device 122 are illustrated with reference to FIGS. 16-21.

In some embodiments, the control interface device 122 is configured with a portable computing device. In some embodiments, the control interface device 122 is configured as a mobile computing device running an application that provides an interface for a user to control the refrigerant management system 102. The control interface device 122 can be wirelessly connected to the control device 136, for example via a local wireless network or short-range wireless communication (e.g., Bluetooth). Alternatively, the control interface device 122 can be connected to the control device 136 through a port, such as a USB port or other wired communication interface.

The control interface device 122 can be configured with one or more handheld mobile devices that are typically used for daily purposes, such as off-the-shelf smartphones, tablets, or PDAs. Such a control interface device 122 can still be used for other purposes when it is not used with the refrigerant management system 102. The control interface device 122 can alternatively configured to be dedicated to the refrigerant management system 102.

As described in more detail below, the portable control interface device 122 is detachably supported by the work panel 104. While the refrigerant management system 102 is in operation with respect to a connected refrigeration system 108, a user can remove the portable control interface device 122 from the work panel 104 and walk away from the refrigerant management system 102, carrying the portable control interface device 122 to perform different tasks or to be present at different locations. As such, the user need not stay with the refrigerant management system 102 while it operates, thereby improving overall work efficiency.

In other embodiments, the control interface device 122 is configured with a mechanical and/or electrical with analog input elements (e.g., analog buttons, control sticks, function keys, keypads, and switches) to receive a user's input or selection for various operations of the refrigerant management system 102. The control interface device 122 can include a display device for showing various pieces of information (e.g., operational status or user input) regarding the refrigerant management system 102.

In some embodiments, the control interface device 122 is made as an independent device and detachably placed in/on the management unit 120 (e.g., the work panel 104). In other embodiments, the control interface device 122 is fixedly secured to the management unit 120.

FIG. 3 describes example operations that can be performed by the refrigerant management system 102. In some embodiments, the refrigerant management system 102 can perform a recovery operation 150, a vacuum operation 152, a charge operation 154, a full cycle operation 156, and an oil injection operation 158. In other embodiments, the refrigerant management system 102 can perform other operations and/or only one or more of the above operations 150, 152, 154, and 156. The control device 136 can be programmed to selectively control the components of the refrigerant management system 102 based on a user input through the control interface device 122.

The recovery operation 150 is performed to fully recover and recycle all refrigerant from the associated refrigeration system 108. For example, if the refrigeration system 108 needs to be opened to atmosphere to replace a part, all refrigerant must be removed before opening the system.

The vacuum operation 152 is performed to remove air and moisture from the refrigeration system 108 by pulling a deep vacuum. This operation can be used after completing a repair that required opening the refrigeration system 108 to the atmosphere. Moisture and contaminants of the refrigeration system can cause erratic operation or degeneration/degradation, and therefore, such moisture and contaminants need to be removed before recharging the system with refrigerant.

The charge operation 154 is performed to add a precise amount of refrigerant when the refrigeration system 108 is low on or completely out of refrigerant. This mode can be used when the refrigeration system is working but is not producing sufficiently cold air.

The full cycle operation 156 is performed to remove and recycle all refrigerant in the refrigeration system 108 by transferring the refrigerant to the storage tank, removing moisture/contaminants in the system by pulling a vacuum, and charging the system with a precise amount of refrigerant.

The oil injection operation 158 is used to inject oil into the refrigeration system 108.

It is noted that any one or more of the above operations may take some time (e.g., a few minutes) to be performed; accordingly, in this use case, detachability of the control interface device 122 may be desirable, allowing the user or mechanic to view remotely the current status of operation of the refrigerant management system 102.

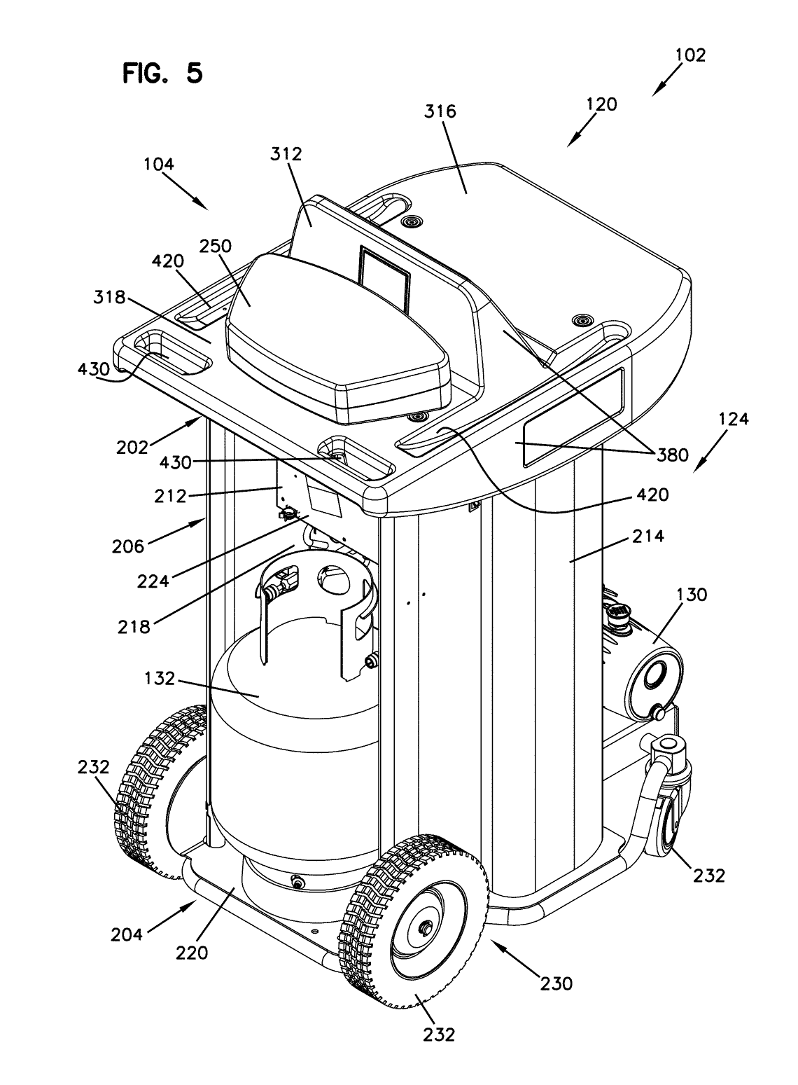

Referring to FIGS. 4 and 5, an example structural arrangement of the refrigerant management system 102 is described. In particular, FIG. 4 is a front schematic perspective view of an example refrigerant management system 102, and FIG. 5 is a rear schematic perspective view of the refrigerant management system 102.

As described above, the refrigerant management system 102 includes the system housing 124, the multifunctional work panel 104, and the control interface device 122.

As illustrated, the system housing 124 is configured as a container or bin. For example, the system housing 124 can be generally cylindrical-shaped or cuboid-shaped. In the illustrated example, the system housing 124 has a top end 202 and a bottom end 204, and includes a lateral surface 206 extending between the top end 202 and the bottom end 204. The system housing 124 is configured such that the lateral surface 206 stands to the bottom end 204. In some embodiments, the lateral surface 206 includes a forward side 210, a rearward side 212, and opposing lateral sides 214 extending between the forward and rearward surfaces 210, 212.

The system housing 124 is configured to provide spaces or seats for placing various components of the refrigerant management system 102. In the illustrated example, the system housing 124 provides a supporting deck 216 for securing the vacuum pump 130 on the forward side 210 of the lateral surface 206. The system housing 124 has a recess 218 for at least partially receiving the storage tank 132 and a supporting portion 220 for supporting the storage tank 132 on the rearward side 212 of the lateral surface 206. Further, the system housing 124 provides a supporting structure 222 for holding the oil extraction reservoir 134 on one of the lateral sides 214 of the lateral surface 206. The system housing 124 further provides a space 224 for receiving the control device 136. In the illustrated example, the control device 136 is received within the space 224 and is not exposed to the exterior of the system housing 124. Other arrangements and structures are also possible for the components of the refrigerant management system 102.

In some embodiments, the system housing 124 includes a transporting device 230 for moving the refrigerant management system 102 to different locations. The transporting device 230 can include one or more wheels 232 arranged at the bottom end 204 of the system housing 124. A user can push or pull the refrigerant management system 102 so that the wheels 232 roll on a ground surface. As such, the refrigerant management system 102 can be conveniently moved to different locations as appropriate for operating the refrigerant management system 102 with respect to an associated refrigeration system 108.

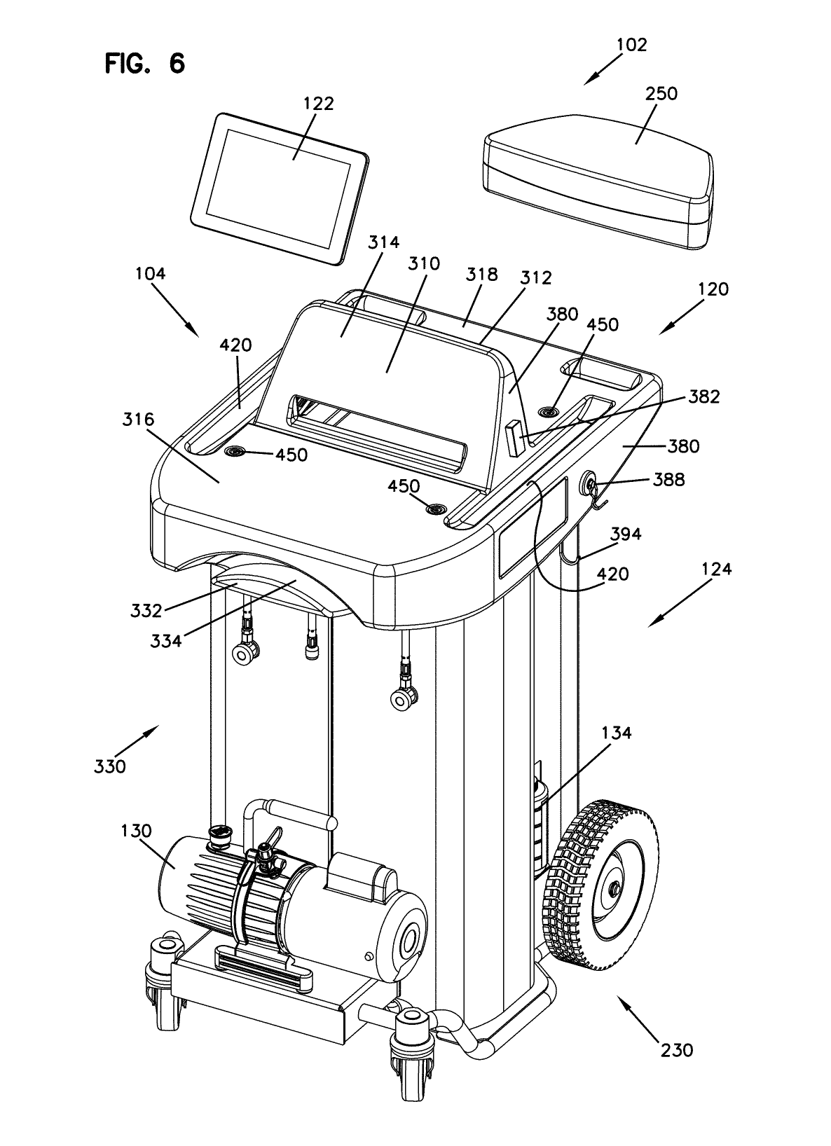

Referring to FIGS. 4-6, an example of the multifunctional work panel 104 is described. FIGS. 4 and 5 illustrate that the control interface device 122 and the refrigerant identifier 106 are placed on the work panel 104. FIG. 6 illustrates that the control interface device 122 and the refrigerant identifier 106 are removed from the work panel 104.

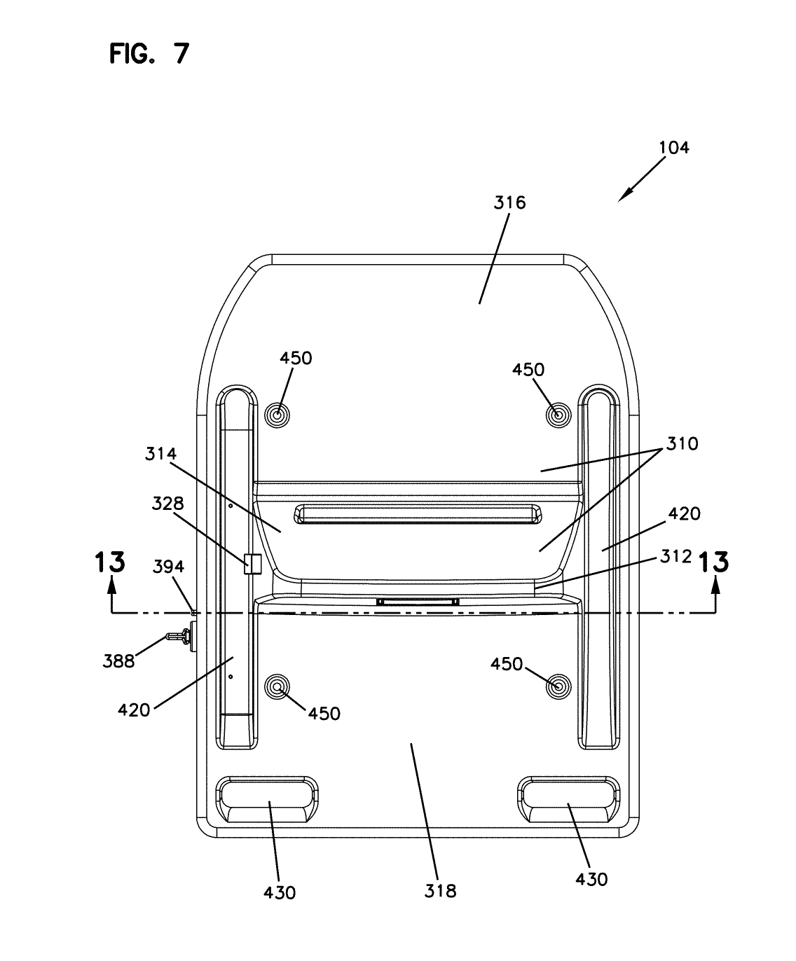

The work panel 104 is secured to the system housing 124. The work panel 104 includes a top portion 302, a bottom portion 304, and a side portion 306. In the illustrated example, the work panel 104 is arranged on the top end 202 on the top portion 302. In some embodiments, the work panel 140 includes one or more fastener holes 450 (FIG. 7) through which fasteners pass to secure the work panel 140 to the system housing 124.

In some embodiments, the work panel 104 is placed at a height H suitable for a user to conveniently access the work panel 104 while the user is standing. The system housing 124 extends upright to provide the height H for the work panel 104.

The multifunctional work panel 104 provides work surfaces or spaces on which a user can perform various tasks in operating the refrigerant management system 102. For example, while operating the refrigerant management system 102, a user can use the work panel 104 to place one or more computing devices (e.g., the control interface device 122), one or more tools or instruments (e.g., mechanical tools, writing instruments), one or more pieces of literature (e.g., books, manuals, papers, documents, files), and other items (e.g., business or personal items or belongings). The user can also place and use these items on the work panel 104. For example, the user can manipulate the control interface device 122 placed on the work panel 104, temporarily place items thereon, write on a paper or object placed thereon, and any other suitable tasks.

The work panel 104 includes an interface placement surface 310 defined on the top portion 302 of the work panel 104. The interface placement surface 310 is configured to allow the control interface device 122 to be placed during operation and/or for storage. In some embodiments, the interface placement surface 310 is configured to detachably support one or more control interface devices 122 of various types or sizes. In some embodiment, the work panel 104 includes a stand 312 extending from the top portion 302 of the work panel 104. The stand 312 can have a support surface 314 that can function as the interface placement surface 310. In some examples, the support surface 314 includes a slanted surface. The support surface 314 can cooperate with another portion (e.g., a first work surface 316) of the work panel 104 to hold the control interface device 122 thereon. For example, while the first work portion 316 of the work panel 104 holds up the bottom of the control interface device 122, the support surface 314 can support the back of the control interface device 122.

The work panel 104 further provides one or more counter top surfaces, such as a first work surface 316 and a second work surface 318, on the top portion 302. In the illustrated example, the first work surface 316 is arranged opposite to the second work surface 318 with the stand 312 therebetween. The counter top surfaces can be used for various purposes, as described above. In some embodiments, the counter top surfaces are configured to be flat on the top portion 302 of the work panel 104.

For example, the first work surface 316 is provided on the top portion 302 of the work panel 104 so as to be arranged in front of the control interface device 122 when the control interface device 122 is held on the support surface 314 of the stand 312. A user can use the first work surface 316 to place various items thereon when operating the control interface device 122, or place a portion of the user's body (e.g., the arms) thereon to conveniently manipulate the control interface device 122.

The second work surface 318 can also be used for various purposes. In the illustrated example, the second work surface 318 is configured to support the refrigerant identifier 106 thereon. The refrigerant identifier 106 can be of various types. Examples of the refrigerant identifier 106 include identifier devices in the Ultima ID series available from Neutronics, Inc. (Exton, Pa.). In other embodiments, the second work surface 318 can be used to hold other items, or can be used similarly to the first work surface 316.

With reference to FIGS. 4, 6, and 8, the management unit 120 includes a hose storage device 330 configured to store the hoses 110 of the refrigerant management system 102. In some embodiments, the work panel 104 includes the hose storage device 330. In other embodiments, the system housing 124 includes the hose storage device 330. In yet other embodiments, the work panel 104 and the system housing 124 are configured to cooperatively provide the hose storage device 330.

In some embodiments, the hose storage device 330 includes a hose rack 332 extending from the side portion 306 of the work panel 104. The hoses 110 can be at least partially wrapped or wound around the hose rack 332. The hose rack 332 can provide a wrap surface 334 on which portions of the hoses 110 are hung. In the illustrated example, the hose rack 332 and the side portion 304 of the work panel 104 define a storage groove 336 around the wrap surface 334, and the hoses 110 can be partially received within the storage groove 366 when the hoses 110 are hung on the wrap surface 334.

With reference to FIGS. 4-8, the work panel 104 includes one or more magnetically attractive portions 380 configured to magnetically hold one or more items that have a portion made of one or more magnetic or ferromagnetic materials. For example, such items include note papers, notepads, files, tools, and any other items that are used by a user. In some examples, the items are at least partially made of metal. In the illustrated example, the magnetically attractive portions 380 are provided on at least part of the side portion 306 of the work panel 104 and the side surfaces of the stand 312, which are easily accessible by a user who stands beside and operate the refrigerant management system 102. In other embodiments, the magnetically attractive portions 380 are provided on other portions of the work panel 104. In yet other embodiments, the work panel 104 is made of magnetically attractive materials.

The work panel 104 further includes one or more magnets 382 attracted to the magnetically attractive portions 380. The magnets 382 cooperate with the magnetically attractive portions 380 to hold various items, such as note papers, notepads, documents, and files, therebetween. For example, one or more papers are held between the magnets 382 and the magnetically attractive portions 380 as the magnets 382 are attached to the magnetically attractive portions 380 by magnetic attraction.

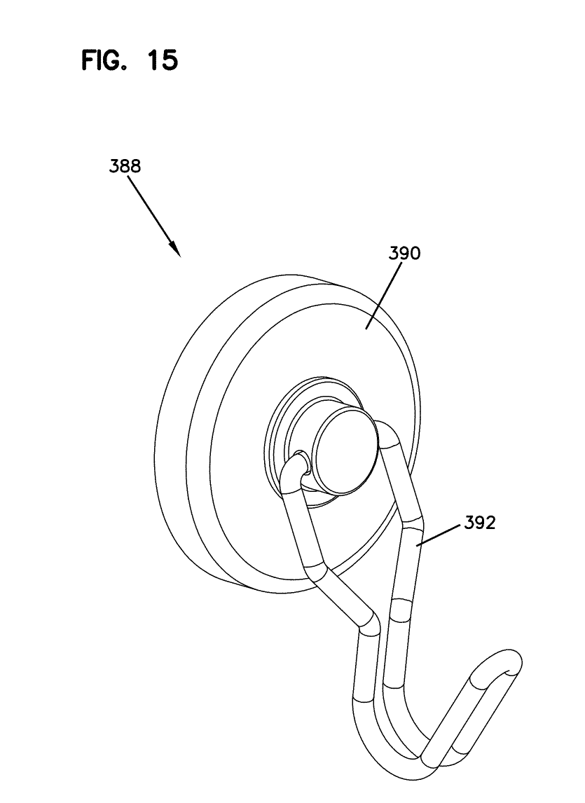

The work panel 104 further includes one or more magnetic hooks 388 configured to hold various items, such as job jacket folders that contain documents related to a particular job or project. For example, a job jacket folder is hung on the magnetic hook 388 while the magnetic hook 388 is placed on the work panel 104. As illustrated in FIG. 15, the magnetic hook 388 includes a body 390 and a hook portion 392 attached to the body 390. In some embodiments, the body 390 is made of a magnet. In other embodiments, the body 390 of the magnetic hook 388 is attached to a small magnet that can be attracted to the magnetically attractive portions 380 of the work panel 104.

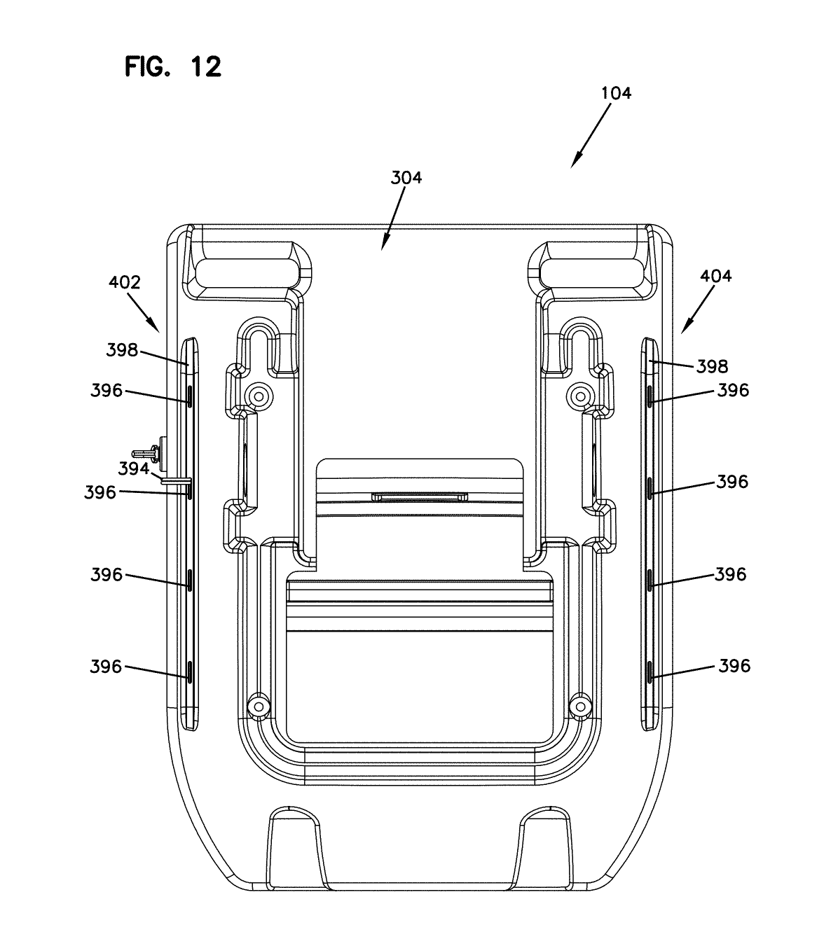

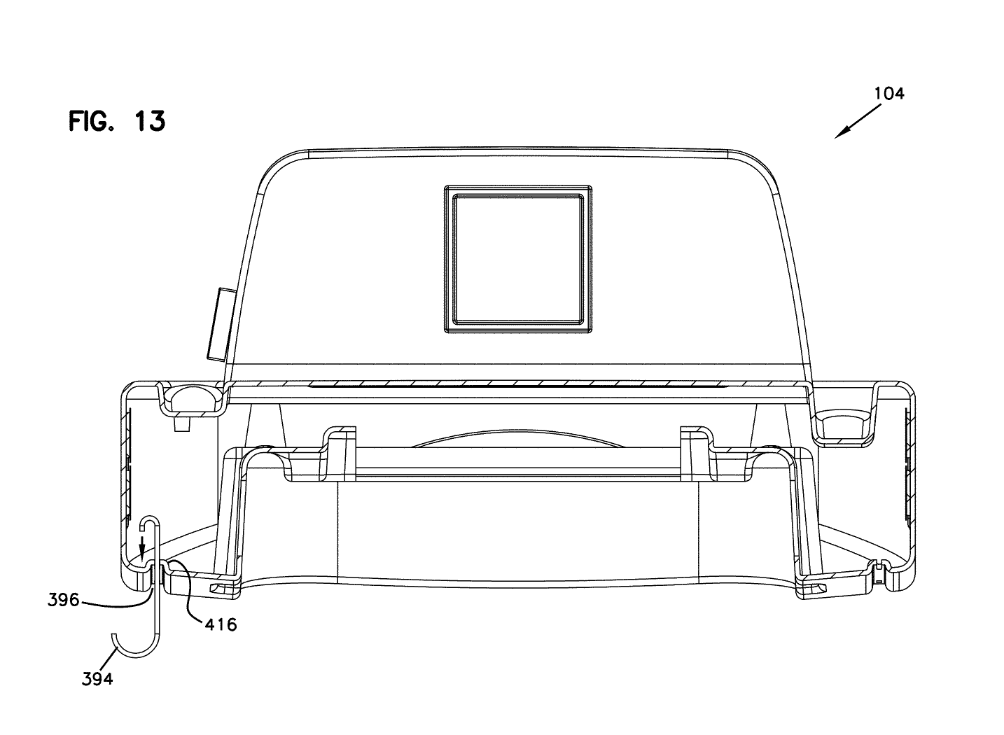

The work panel 104 includes one or more hanging hook 394 for hanging one or more items, such as rags, tools, and any other objects that can be hung on a hook. In the illustrated example, the hanging hook 394 can be arranged at, and extend from, the right and left sides of the work panel 104. As shown in FIGS. 12 and 13, the work panel 104 includes one or more hook engaging slot 396 for engaging the hanging hook 394. In this example, the work panel 104 includes longitudinal channels or grooves 398 adjacent to and along the right and left edges 402, 404 on the bottom portion 304 of the work panel 104, and one or more hook engaging slots 396 are provided within the grooves 398. The channels 398 with the hook engaging slots 396 are exposed downwards when the work panel 104 is attached to the system housing 124. As shown in FIG. 12, the hook engaging slots 396 are spaced apart at intervals along each of the longitudinal channels 398. Each hanging hook 394 can be inserted into, and engaged with, any of the hook engaging slots 396 in a manner described below.

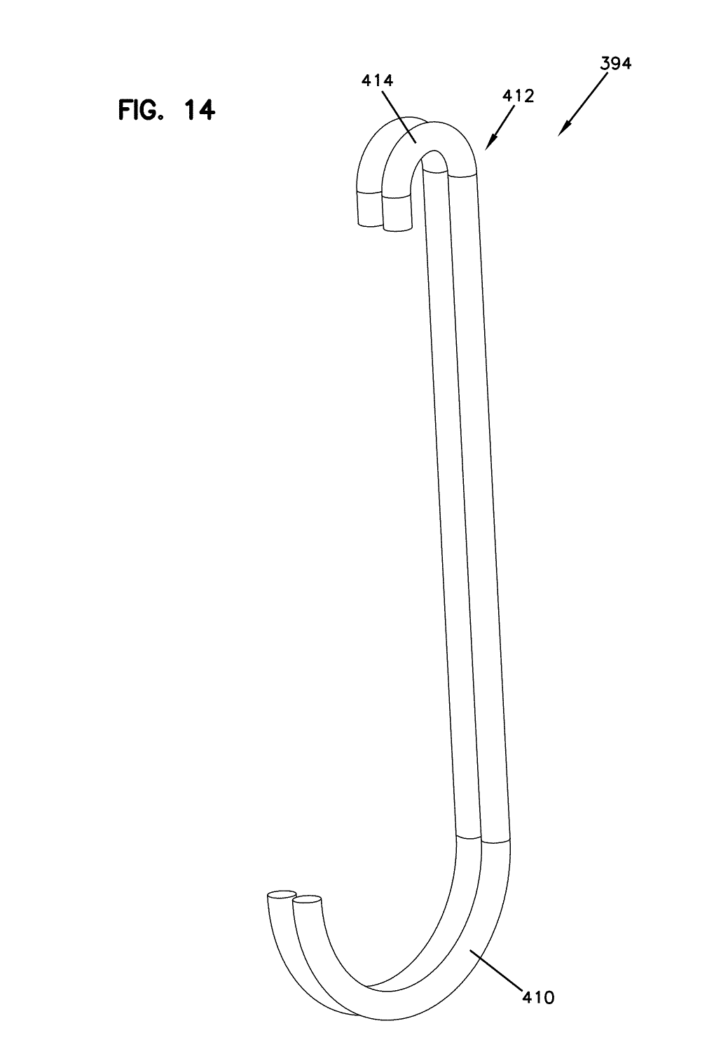

Referring to FIG. 14, the hanging hook 394 includes a hook portion 410 and an engaging portion 412. The hanging hook 394 is dimensioned such that the engaging portion 412 is inserted through the hook engaging slot 396. The engaging portion 412 includes a catching portion 414 configured to hook the hanging hook 394 to a portion of the work panel 104 within the work panel 104, as illustrated in FIG. 13. Once the engaging portion 412 is inserted through the hook engaging slot 396, the hanging hook 394 can then be turned (e.g., about 90 degree) such that the catching portion 414 of the engaging portion 412 is caught by an inner portion (e.g., a ridge 416) of the work panel 104.

Referring to FIGS. 4-7, the work panel 104 includes one or more trays 420 for receiving and storing various items, such as documents, tools, and other objects. In some embodiments, the trays 420 are defined as recesses or grooves of the work panel 104 and accessible from the top portion 302 of the work panel 104. In the illustrated example, the trays 420 are longitudinal recesses provided adjacent the sides of the top portion 302 of the work panel 104. Other arrangements are also possible. The trays 420 can be divided into multiple segments having different dimensions (e.g., length, depth, and width) for receiving different types and sizes of items.

Referring to FIGS. 4-7, the work panel 104 includes a handle 430 for moving the management unit 120 (i.e., the system housing 124 with the work panel 104). The handle 430 is configured for a user to grab to push or pull the management unit 120 using the transporting device 230 (e.g., the wheels 232). In the illustrated embodiments, the handle 430 is defined as one or more grooves on the work panel 104. Various configurations of the handle 430 are possible in other embodiments.

Referring now to FIGS. 1-14 generally, it is noted that the refrigerant management system 102, and various embodiments thereof, have a number of advantages over existing systems. For example, embodiments of such a system provide improved flexibility with respect to communication with refrigerant identifiers, allowing for interchangeable use with different refrigerant identifiers made by different manufacturers. Additionally, portability of a control interface device, such as control interface device 122, allows for more efficient work by the user of the system by allowing the user to monitor operation of the system remotely, to control each of the functions of the system centrally, and to communicate data to peripheral equipment as may be desired. Furthermore, the structural features of such a system allow for ease of use in a workplace environment, due to convenience of storage and workspace surface features of the system.

In some examples, the work panel 104 is configured to detachably secure a storage bag that provides a plurality of pockets and/or containers for store various items, such as beverage, cells, and job paperwork. For example, such a storage bag is secured to the tray 420 and hangs in the side of the work panel 104.

Referring to FIGS. 16-21, a user interface 500 provided by the control interface device 122 is described in accordance with an exemplary embodiment of the present disclosure. The user interface 500 can be a graphic user interface that is displayed on a display screen of the control interface device 122.

Referring to FIG. 16, the user interface 500 can provide a menu display with a plurality of options, such as for performing services (via a control element 502), for choosing reports (via a control element 504), for configuring the system (via a control element 506), for performing maintenance (via a control element 508), and for exiting the user interface (via a control element 510). Other options are available in other examples.

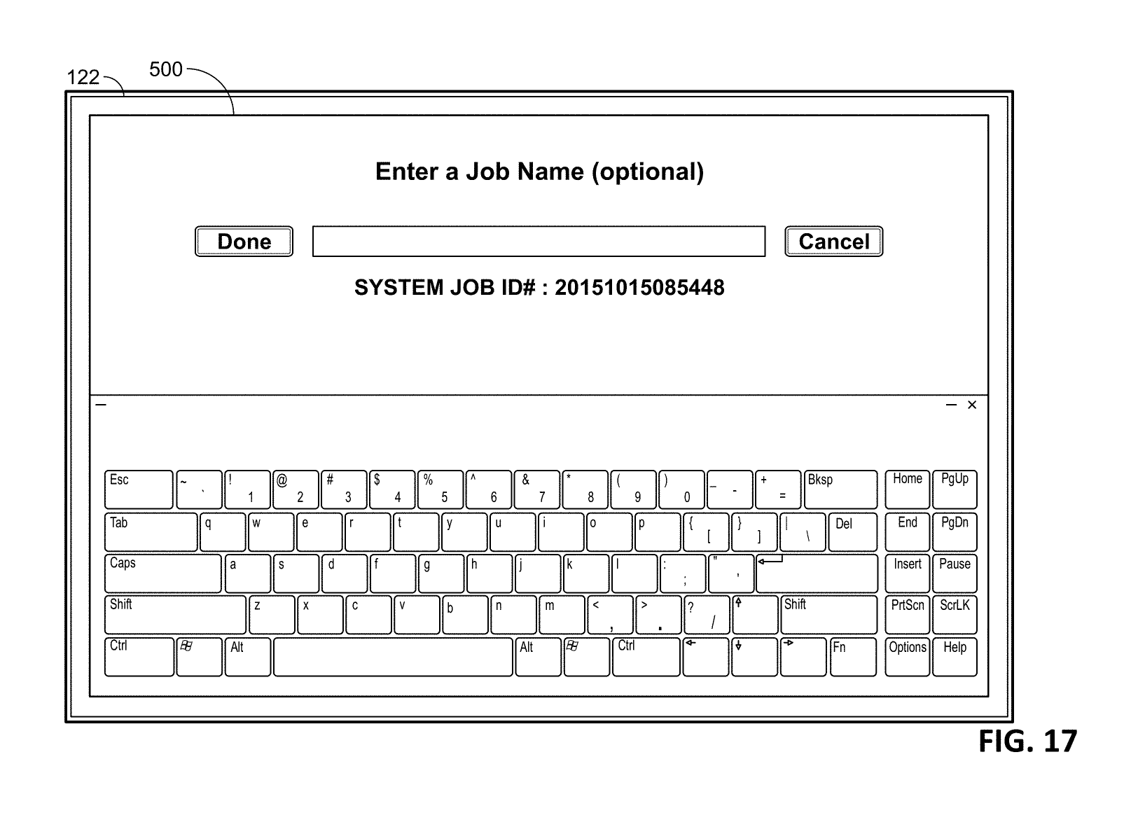

As illustrated in FIG. 17, the user interface 500 can enable a user to set up a job name associated with a system job ID that represents an operation with the system.

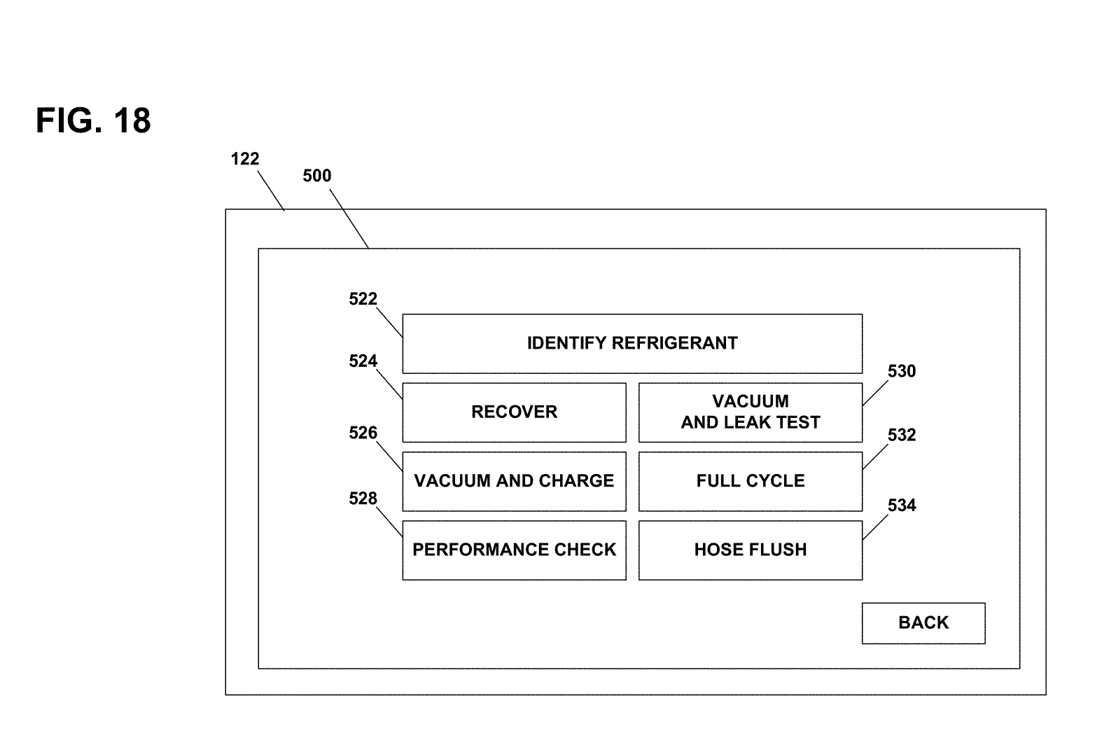

Referring to FIG. 18, the user interface 500 provides a plurality of control elements for various operations, such as for identifying a refrigerant (via a control element 522), for performing recovery (via a control element 524), for performing vacuum and charging (via a control element 526), for performing performance check (via a control element 528), for performing vacuum and leak test (via a control element 530), for performing a full cycle (via control element 532), and for flushing a hose (via a control element 534). In other examples, other operations are available with the system and selectable via the user interface 500.

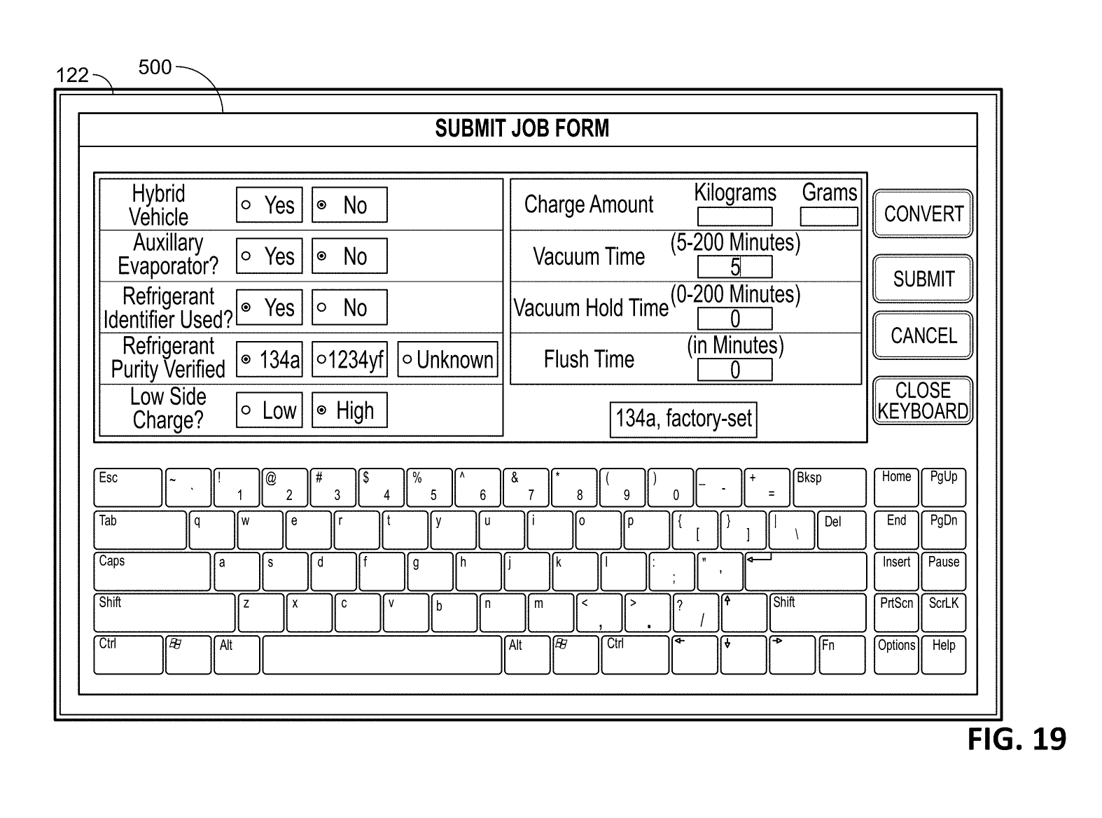

As illustrated in FIG. 19, the user interface 500 can provide a screen for enabling a user to select and/or adjust various parameters and requirements for an operation.

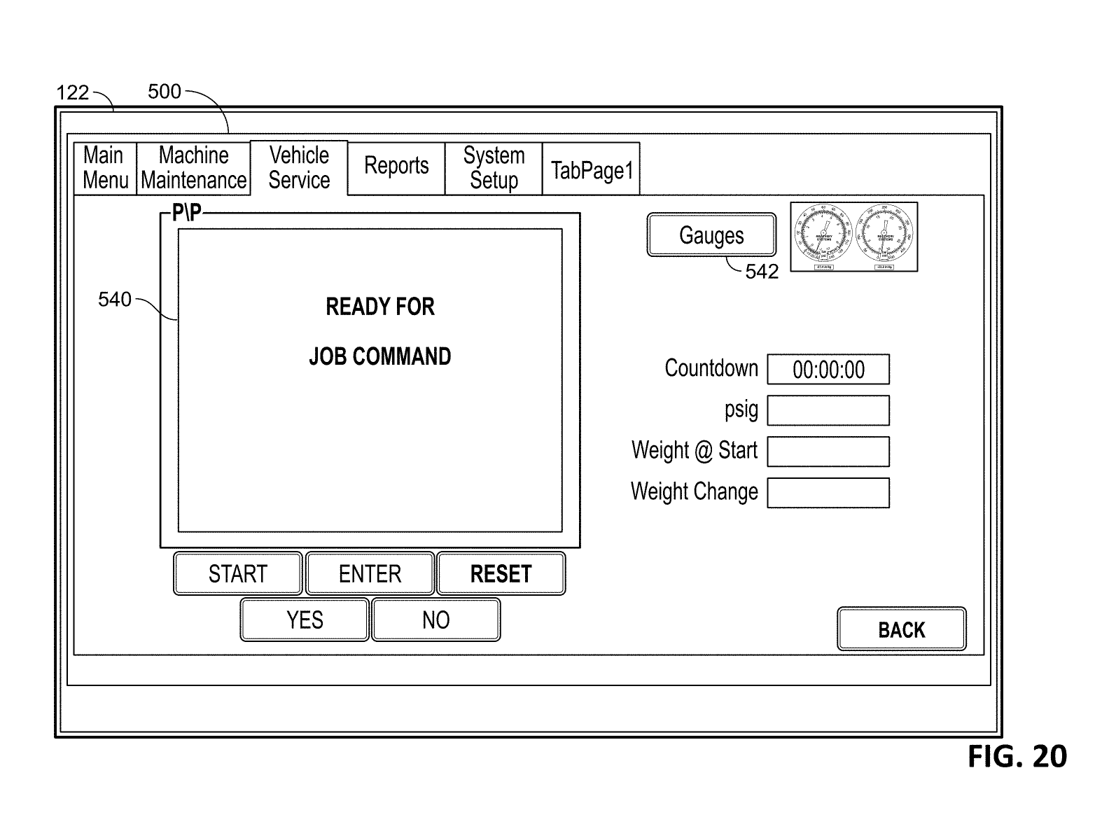

As illustrated in FIG. 20, the user interface 500 can provide a window that guides a user to perform particular operations. For example, the user interface 500 can include an instruction window 540 on which commands are provided to guide a user to complete an operation. The user can take a series of actions, following the commands presented on the instruction window 540.

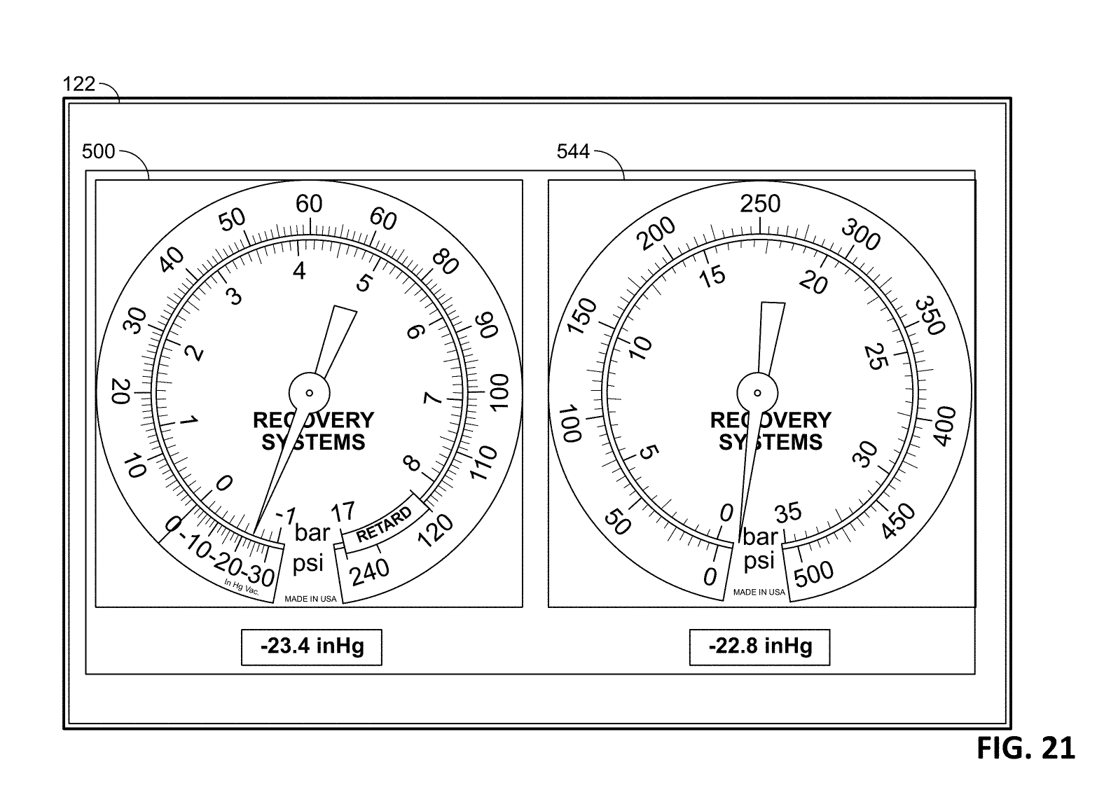

The user interface 500 can include a control element 542 that leads to a gauge screen 544 when selected. An example of the gauge screen 544 is illustrated in FIG. 21.

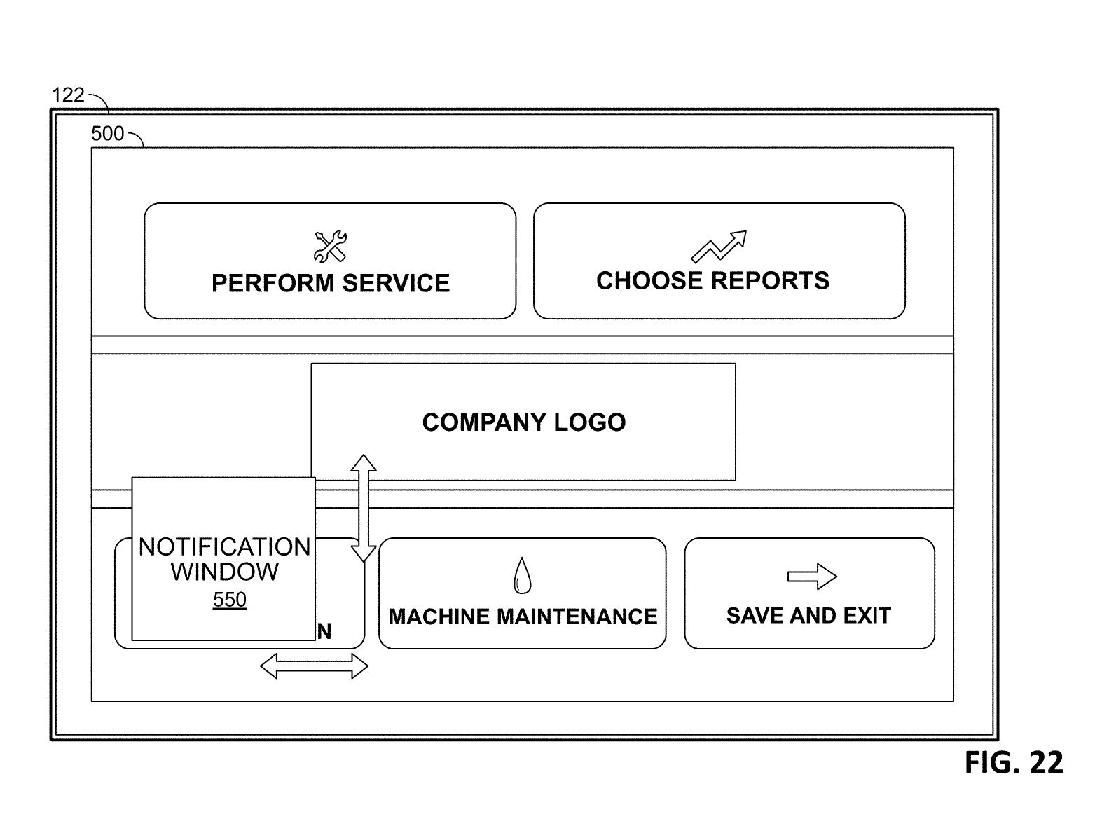

Referring to FIG. 22, the user interface 500 can include a notification window 550 configured to provide various types of information. The notification window 550 can be used for various purposes, such as delivering advertisement, system update notice, and other information related or unrelated to the operation of the system. In some examples, the notification window 550 can be configured as a slide-in window or box, a pop-up window or box, or an overlay window or box, which can be presented over an underlying display. The notification window 550 can be configured to move around over the underlying display.

In accordance with an exemplary embodiment of the present disclosure, the refrigerant management system 102 is assigned identification information (e.g., a serial number) that can be used to identify the refrigerant management system 102. In some examples, the system 100 includes a remote computing device, and data stored and/or generated by the refrigerant management system 102 can be transmitted to the remote computing device via a network. Such data can include various information associated with the refrigerant management system 102, such as operation results, system status, configuration information, and other information including a location of the system 102. The data can be stored, analyzed, and/or evaluated in the remote computing device for various purposes. When the data is transferred to the remote computing device, the identification information of the refrigerant management system 102 can also be transmitted to the remote computing device and used to identify the refrigerant management system 102 and verify the data.

Referring to FIGS. 1-22 generally, it is noted that the refrigerant management system of the present disclosure has a number of advantages over existing systems regarding flexibility and ease of use. For example, the refrigerant management system disclosed herein allows for remote operation via a control device that is at least partially removable from the main housing of the system, allowing a service technician to monitor and control operation of the refrigerant management system from various locations within a maintenance facility. Additionally, the work surface and storage/organization features of the refrigerant management system described herein provide improved useability for such technicians. Other advantages are provided as well, which are apparent from the above disclosure.

The various examples and teachings described above are provided by way of illustration only and should not be construed to limit the scope of the present disclosure. Those skilled in the art will readily recognize various modifications and changes that may be made without following the example examples and applications illustrated and described herein, and without departing from the true spirit and scope of the present disclosure.

What is claimed is:

1. A refrigerant management system comprising:
a housing configured to secure at least one of an oil extraction reservoir, a storage tank, and a vacuum pump; and
a work panel secured to the housing and having a top portion and a side portion, the work panel including a work surface defined on the top portion, the work surface including a stand extending from the top portion of the work panel and having a support surface configured to detachably support a portable control device thereon.

2. The system of claim 1, further comprising a portable control device, the portable control device providing a user interface for managing a refrigeration system using at least one of the oil extraction reservoir, the storage tank, and the vacuum pump.

3. The system of claim 1, wherein the work surface of the work panel includes a flat countertop surface defined on the top portion of the work panel.

4. The system of claim 1, wherein the work panel includes a hose storage device configured to store hoses extending from the refrigerant management system.

5. The system of claim 4, wherein the hose storage device includes a hose rack extending from the side portion of the work panel, the hose rack providing a wrap surface around which the hoses are at least partially wound.

6. The system of claim 1, wherein the work panel includes one or more magnetically attractive portions configured to hold one or more items having a portion made of one or more magnetic or ferromagnetic materials.

7. The system of claim 6, wherein the work panel includes one or more magnets attracted to the magnetically attractive portions and configured to hold the one or more items between the magnets and the magnetically attractive portions.

8. The system of claim 6, wherein the work panel includes a magnetic hook magnetically attached to the magnetically attractive portions and configured to hold one or more job jackets.

9. The system of claim 1, wherein the work panel includes a hanging hook for hanging one or more items, the hook arranged on the side portion of the work panel.

10. The system of claim 1, wherein the work panel includes one or more trays defined on the top portion of the work panel.

11. The system of claim 1, wherein the work panel includes a handle for moving the housing.

12. The system of claim 1, wherein the work panel includes an interface through which a refrigerant identifying device is connected.

13. The system of claim 1, wherein the work panel is arranged at a height that enables a user to access the work surface while standing.

14. The system of claim 1, wherein the housing includes a transporting device, the transporting device including one or more wheels arranged at a bottom of the housing.

15. An automotive refrigerant management system comprising:
an oil extraction reservoir;
a storage tank;
a vacuum pump;
a portable control interface device configured to receive a user input;
a control device receiving data from the portable control interface device and performing at least one of recovery operation, vacuum operation, charge operation, full cycle operation, and oil injection operation;
a movable system housing securing the oil extraction reservoir, the storage tank, the vacuum pump, and the control device; and
a work panel secured to the system housing, the work panel including:
a stand extending from a top portion of the work panel and having a support surface configured to detachably support the portable control interface device; and
a countertop surface on the top portion of the work panel.

16. The system of claim 15, wherein the work panel includes a hose storage device configured to store hoses extending from the refrigerant management system.

17. The system of claim 15, wherein the work panel includes:
one or more magnetically attractive portions; and
one or more magnets attracted to the magnetically attractive portions and configured to hold the one or more items between the magnets and the magnetically attractive portions.

18. The system of claim 17, wherein the work panel includes a magnetic hook magnetically attached to the magnetically attractive portions and configured to hold one or more job jackets.

19. The system of claim 15, wherein the work panel includes a hanging hook for hanging one or more items, the hook arranged on the side portion of the work panel.

20. The system of claim 15, wherein the work panel includes one or more trays defined on the top portion of the work panel.
